(19) United States
(12) Patent Application Publication
(10) Pub. No.: US 2020/0282596 A1
(43) Pub. Date: Sep. 10, 2020

(54) INTERLAYER MIXING APPARATUS FOR TEXTURING MAN-MADE STONE SLABS

(71) Applicant: Veegoo Technology Co. Ltd., Guangdong (CN)

(72) Inventors: Jianping Qiu, Guangdong (CN); Shiyang Zhu, Guangdong (CN); Yexin Pan, Guangdong (CN)

(73) Assignee: Veegoo Technology Co. Ltd.

(21) Appl. No.: 16/858,946

(22) Filed: Apr. 27, 2020

Related U.S. Application Data
(63) Continuation-in-part of application No. PCT/CN2018/077367, filed on Feb. 27, 2018.

(51) Int. Cl. B28C 7/02; B28C 7/12; B44F 9/04

(52) U.S. Cl. CPC B28C 7/02; B44F 9/04; B28C 7/128

(57) ABSTRACT

An interlayer mixing apparatus for texturing man-made stone slabs has a pressing assembly, a coloring component, a stirring assembly, a moving assembly, and a control system. A conveyor belt sequentially conveys a slab to working areas of the pressing assembly, the coloring component, and the stirring assembly which are separately connected to the control system. The pressing assembly presses the slab before the pigment and the slab are stirred, so that the texture boundary on the final product is clearer and more complete. The control system moves the moving assembly to position the stirring assembly according to a texture route, while the stirring assembly performs stirring on a part of the surface of the slab, to stir a pigment layer with a raw material layer on the slab.

The present application claims priority from and is a Track One PCT bypass continuation in part of PCT/CN2018/077367, filed Feb. 27, 2018 entitled Interlayer Mixing Apparatus For Texturing Man-Made Stone Slabs 17, 2017 by applicant Feizhou DENG, and by inventors Jianping Q I U, Shiyang Z H U, Yexin P A N, now assigned to Veegoo Technology Co. Ltd., which was published as WO 2019/095583 on May 23, 2019 and based on China patent application 201711142295.6 filed Nov. 17, 2017, the disclosure of which is incorporated herein by reference.

### TECHNICAL FIELD

The invention relates to the field of artificial stone texture processing, in particular to an interlayer mixing device for artificial stone plate texture processing.

### BACKGROUND

Artificial quartz stone countertops are one way to liven up a kitchen or bath and provide a high-end durable material. Artificial quartz stone has more than 90% natural quartz and about 10% color material, resin and other additives that adjust adhesion, curing, etc. Artificial quartz stone slab also called a plate is processed by negative pressure vacuum, high frequency vibration molding, heating and curing production methods.

To make artificial quartz stone countertops less artificial looking, it is desired to have nonuniform texture such as in natural stone slabs. In the existing artificial quartz stone technology, in order to create a texture trend effect similar to natural stone, it is necessary to put a texture mold frame in the fabric process. After the fabric is finished, the texture mold frame is removed, and the material produced shows a texture line. The disadvantages of this technology are: (1) a texture mold frame can only make a texture line effect, and to change the texture line, the texture mold frame must be retooled; (2) filling the texture line with colorant requires manual operation, and lacks production automation; and (3) the texture effect lacks a gradient of multiple color materials, which is very different from real natural stone texture.

### SUMMARY OF INVENTION

The main object of the present invention is to create an automatic assembly line system for texturing artificial stone slabs by providing an interlayer mixing device for automatic texture generation on artificial stone slabs. An interlayer mixing device for artificial stone slab texture processing includes a pressing assembly, a color application component, a stirring component, a moving component, and a control system for the slab material to be transported between stations. A slab conveyor belt moves the slab between the pressing assembly and the color application in a sequence of working areas of a material component and a stirring component. The material pressing assembly, the color application component, the moving component and the stirring component are respectively connected to the control system.

The control system adjusts the pressing assembly so that the pressing assembly applies squeezing force to the slab. The color application component applies at least one layer of colorant to the surface of the slab to which the pressing force has been applied, or according to the design path of the final product texture, applies at least one layer of coloring material on the corresponding position on the surface of the slab. The control system adjusts the moving component and the stirring component so that the moving component drives the stirring component above the slab after the squeezing force is applied and moves according to the set route of the final product texture. The stirring assembly performs stirring at all corresponding positions or partial corresponding positions on the surface of the slab material, and the stirring occurs between the color material and the raw material mixture of the slab material.

Preferably, the pressing assembly and the stirring component are relatively independently arranged at two stations. Before the slab material to which the pressing force is applied enters the working area of the stirring component, apply colorant to the surface of the slab. Preferably, the cloth color application component is disposed on the conveying path of the conveyor belt, and includes a cloth hopper, a discharge roller and a screen. The discharge roller is disposed at the outlet of the cloth hopper for driving. The color material falls to the slab surface of the conveyor belt, the screen is disposed below the discharge roller, and the control system drives the discharge roller to rotate.

Preferably, the color application component is disposed on the conveying path of the conveyor belt, and includes a color material spray head and a storage barrel. The interior of the storage barrel is divided into a plurality of opposite directions along the width direction of the conveyor belt. In an independent interval, the colorant spray head is disposed at the bottom of the interval, and the control system adjusts the opening and closing of the on-off control valve of the colorant spray head.

Preferably, the material pressing assembly includes a cloth belt, a rolling belt and a walking device for flatly storing the material. The cloth belt and the rolling belt are arranged on the same walking device, and the rolling belt undertake set under the cloth belt. The walking device can be linearly reciprocated above the cloth platform, and during its movement, the rolling belt can push and press the material on the cloth platform. Preferably, the color application component and the stirring component are arranged at the same station.

Preferably, the color application component is provided on the moving component, and is moved by the moving component together with the stirring component. The color application component includes a colorant spray head and a color storage bucket, the color material spraying head communicates with the color material storage barrel through a conveying pipe. Preferably, the pressing assembly, the color application component and the stirring component are provided on a rack. The color application component includes a color spray head, a color pump and a color storage barrel, and the color spray head is disposed thereon. In the moving assembly, the color storage material barrel is independently provided on one side of the frame, and the color material pump is provided on a conveying pipe between the color storage material barrel and the color material spray head.

Preferably, the interlayer mixing device is provided on a rack, and the rack is provided with a platform for receiving the slab material. The pressing assembly is slidably arranged in the frame along the conveying direction of the slab, and includes a pressing roller and a rotating seat. The length direction of the pressing roller is perpendicular to the conveying direction of the slab. Both ends are rotatably disposed on the rotating base, and the rotating base is disposed on the frame through a wheel body, so that when the pressing assembly slides along the conveying direction of the slab material, the pressing roller squeezes and rolls over the end face of the slab.

Preferably, the moving component is an XYZ three-axis drive device, which can drive the stirring component to perform linear reciprocating motion in the X-axis, Y-axis, and Z-axis directions relative to the rack, and the XYZ three-axis drive device is electrically connected to the control system.

The stirring assembly includes a stirring blade and a driving device, and the driving device can drive the stirring blade to rotate in a vertical plane. The driving device includes a spindle driving motor, a stirring spindle, a spindle reducer, a hollow rotating table and a C-axis motor. The spindle driving motor drives the stirring spindle to rotate, and the stirring spindle passes through the hollow rotating table and drives the output shaft of the spindle reducer to rotate. The output shaft of the spindle reducer is arranged horizontally and horizontally, and it drives the stirring blade to rotate in a vertical plane.

The C-axis motor is provided on one side of the stirring spindle, and its output shaft can drive the spindle reducer to rotate relative to the stirring spindle. Then the stirring blade rotates with the spindle reducer relative to the stirring spindle.

In technical implementation, the pressing assembly and the stirring component can be set at the same station, or can be set at two relatively independent stations respectively, and the two relatively independent stations are connected by a conveyor belt. Driven by the conveyor belt, it first moves to the working area of the pressing assembly. The pressing assembly applies a certain squeezing force to the slab. Then, the color application component applies at least one layer of color to the surface of the plate, or according to the design path of the final product texture, applies at least one layer of color material uniformly or unevenly at the corresponding position on the surface of the slab. After the application of the coloring material is completed, the slab material reaches the working area of the stirring component, and the moving component drives the stirring component to move along the extension path of the final product texture, and at the same time, the stirring component stirs at the corresponding position on the texture of the slab material. Stirring occurs between the coloring material and the raw material mixture. The depth of the stirring may involve the thickness of the entire slab. The position of the agitated position after stirring and the position of the unstirred position will produce a color difference. Inside the mixture, after the texture processing and subsequent curing, pressing, thickness setting and other processes are completed, a transparent texture effect is left on the surface of the slab.

Before stirring, a certain pressing force is applied to the slab material through the pressing assembly, so that the stirring occurs between the raw material mixture and the color material of the more compact slab material, and the material at the stirring position becomes loose again, which is in line with it. The material in the adjacent unstirred position is compacted due to the previous pressing, and there is a large barrier that allows the colorant to penetrate, so that the colorant is well maintained at the position where it is stirred, macroscopically making the texture limit on the final product more clear and complete, and the consistency of the upper and lower textures and the texture permeability good. The texture effects of the surface and the bottom layer are very clear, which achieves a natural crack effect.

### CLAIMS SUMMARY

The interlayer mixing device for texture processing of artificial stone slabs has a frame formed as a rack; a pressing assembly mounted on the rack; a color application component mounted on the rack; a stirring component mounted on the rack; a moving component mounted on the rack; and a control system. Plate materials are transported to pressing materials in sequence by a conveyor belt to working areas of the color application component and the stirring component. The pressing assembly, the color application component, the moving component and the stirring component are respectively connected to the control system. The control system adjusts the pressing assembly so that the pressing assembly applies squeezing force to a slab. The color application component distributes at least one layer of coloring material to a slab to which pressing force has been applied or follows a path of a texture design on the slab. At least one color layer is applied on the slab. The control system adjusts the moving component and the stirring component so that the moving component drives the stirring component above the slab material after the pressing force is applied. The control system sets a route of the final product texture while at the same time controlling the stirring component to stir at all corresponding positions or partial corresponding positions on the surface of the slab, stirring occurs at an interface between the color layer and raw material mixture between the plates.

Optionally, the pressing assembly and the stirring component are independently arranged in two stations. The color application component is subjected to a squeezing force. Before the slab material enters the working area of the stirring assembly the color application component applies colorant to the surface of the slab material.

The color application component has a cloth material and is disposed on the conveying path of the conveyor belt, and includes a cloth hopper, a discharge roller and a screen providing a discharge. The roller is provided at the outlet of the cloth hopper for driving the color material to fall to the surface of the slab of the conveyor belt. The screen is provided below the discharge roller, and the control system drives the outlet the feed roller rotates.

The color application component is disposed on the conveying path of the conveyor belt, and includes a color material spray head and a storage barrel; wherein the interior is divided into a plurality of relatively independent interval sections along the width direction of the conveyor belt, the toner nozzle is disposed at the bottom of the interval section, and the control system adjusts the opening and closing of the on-off control valve of the toner nozzle. The pressing assembly includes a cloth belt, a rolling belt and a walking device for flatly storing the stone material, the cloth belt and the rolling device. The belt is arranged on the same walking device, and the rolling belt is arranged under the cloth belt. The walking device can be linearly reciprocated above the cloth platform, and during its movement, wherein the rolling belt can push and squeeze the dough on the cloth platform.

The color application component and the stirring component can be arranged at the same station. The color application component can be mounted on the moving component and moved by the moving component together with the stirring component. The material assembly includes a color material spray head and a color storage material barrel. The color material spray head communicates with the color storage material barrel through a conveying pipe.

The pressing assembly, the color application component and the stirring component are mounted on the rack. The color application component includes a coloring material spraying head and a coloring material pump and a color storage barrel. The color spray head is disposed on the moving assembly, the color storage barrel is independently disposed on one side of the frame, and the color storage barrel is between the color storage barrel and the color spray head. The coloring material pump is arranged on the conveying pipe.

The frame can also be provided with a platform for receiving the stone slab material. The pressing assembly, the color application component, the stirring component and the moving component are glidingly arranged on the frame in the conveying direction of the slab material. A pressing roller and a rotating base offer additional functions. A lengthwise direction of the pressing roller is perpendicular to the conveying direction of the slab material, and both ends thereof are rotatably arranged. The rotating base is disposed on the frame through a wheel body, so that when the pressing assembly slides along the conveying direction of the slab, the pressing roller squeezes from the end surface of the slab roll over.

The moving component is an XYZ three-axis drive device which drives the stirring component relative to the frame in the three X-axis, Y-axis and Z-axis directions. The XYZ three-axis drive device is electrically connected to the control system. The stirring assembly includes a stirring blade and a driving device. The driving device can drive the stirring blade to rotate in a vertical plane. The driving device includes a spindle drive motor, a stirring spindle, a spindle reducer, a hollow rotary table, and a C-axis motor. The spindle drive motor drives the stirring spindle to rotate, and the stirring spindle passes through the hollow rotary table and drive the output shaft of the spindle reducer to rotate. The output shaft of the spindle reducer is arranged horizontally and horizontally, and drives the stirring blade to rotate in a vertical plane. The C-axis motor is provided with the stirring spindle on one side, and an output shaft drives the spindle reducer to rotate relative to the stirring spindle. The stirring blade rotates with the spindle reducer relative to the stirring spindle.

### BRIEF DESCRIPTION

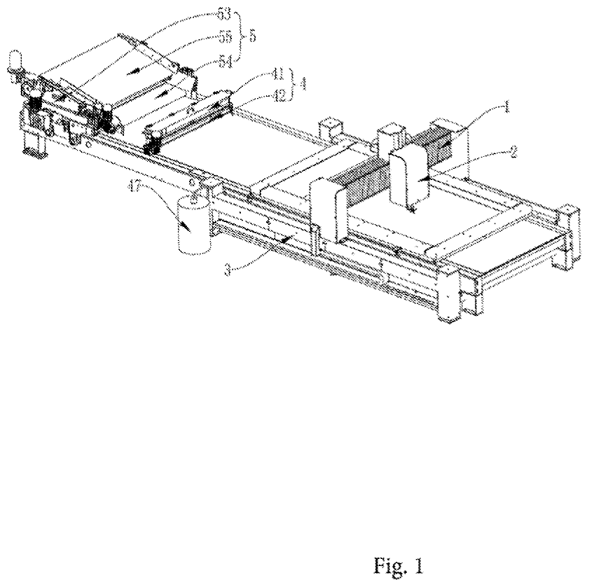

FIG. 1 is a schematic structural view of an embodiment of the present invention where the stirring assembly and the pressing assembly are not in the same station.

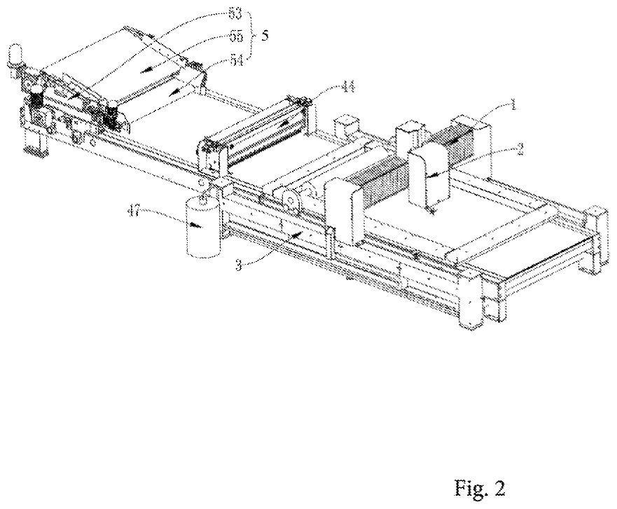

FIG. 2 is a schematic structural view of another embodiment of the present invention where the stirring component and the pressing assembly are not in the same station.

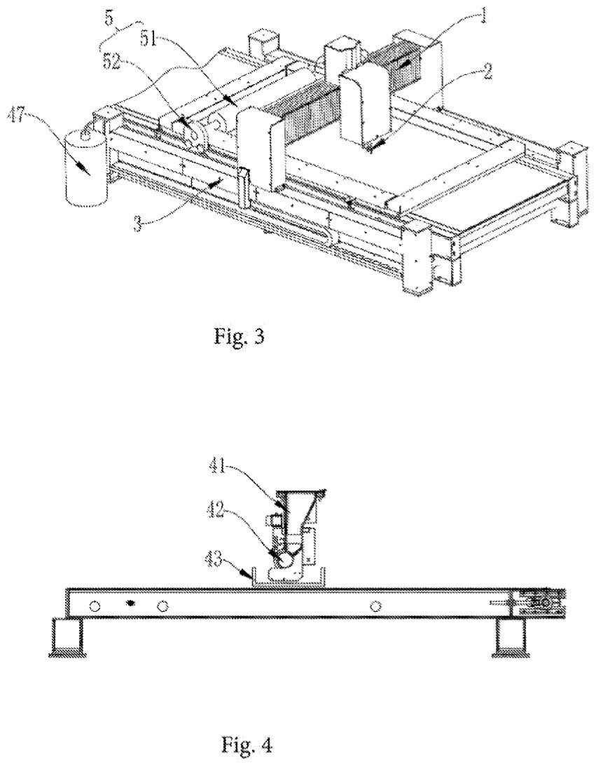

FIG. 3 is a schematic structural view of an embodiment of the present invention in which the stirring assembly and the pressing assembly are arranged at the same station.

FIG. 4 is a side view of the first embodiment of applying colorant components in the present invention.

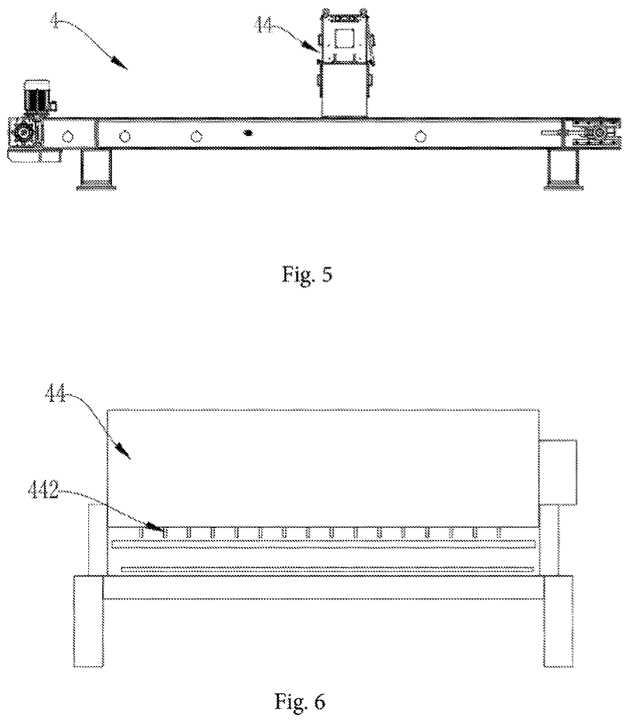

FIG. 5 is a front view of a first embodiment of applying colorant components in the present invention.

FIG. 6 is a front view of a second embodiment of applying colorant components in the present invention.

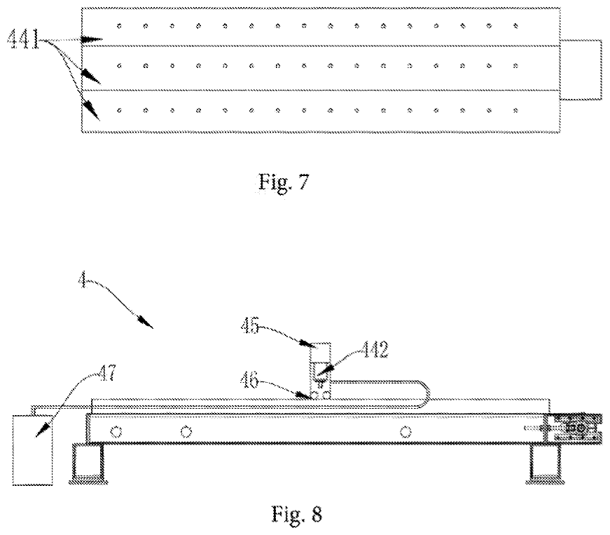

FIG. 7 is a plan view of a second embodiment of applying colorant components in the present invention.

FIG. 8 is a side view of a fourth embodiment of applying colorant components in the present invention.

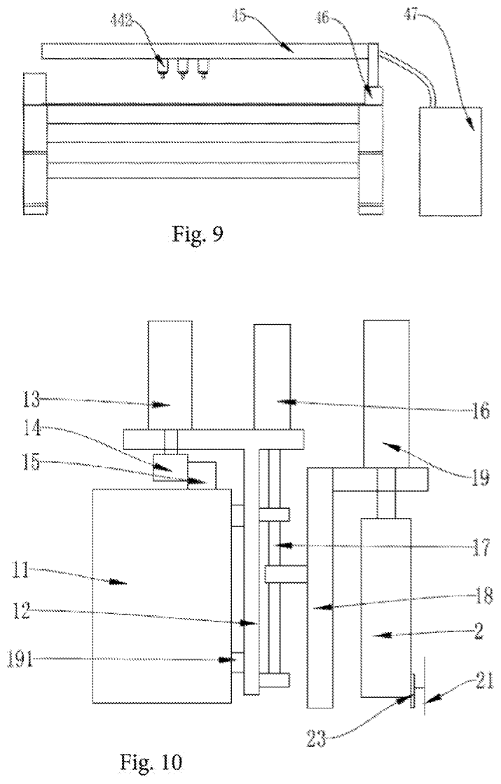

FIG. 9 is a front view of a fourth embodiment of applying colorant components in the present invention.

FIG. 10 is a schematic structural view of an embodiment of a mobile component in the present invention.

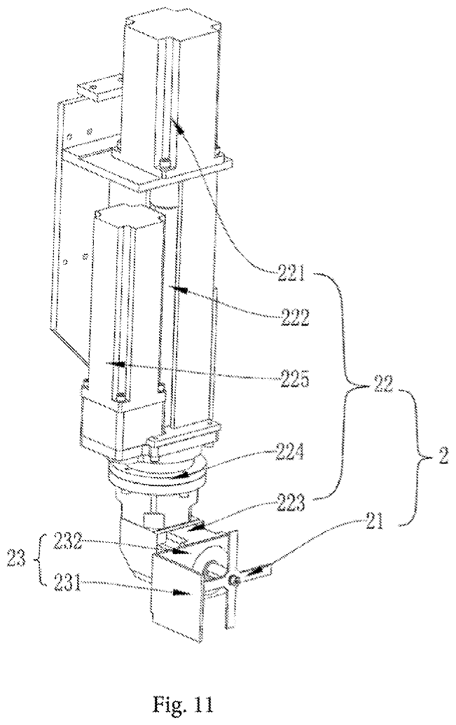

FIG. 11 is a perspective view of an embodiment of the stirring assembly of the present invention.

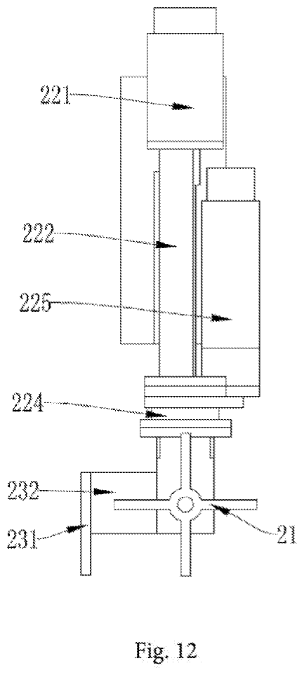

FIG. 12 is a front view of an embodiment of the stirring assembly of the present invention.

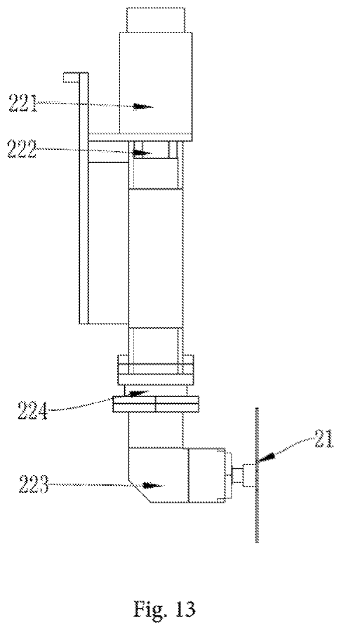

FIG. 13 is a side view of an embodiment of the stirring assembly of the present invention.

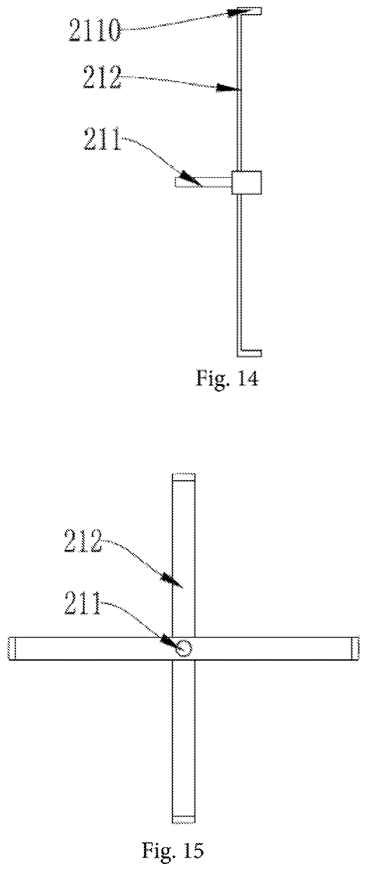

FIG. 14 is a side view of an embodiment of the stirring blade of the present invention.

FIG. 15 is a front view of an embodiment of the stirring blade of the present invention.

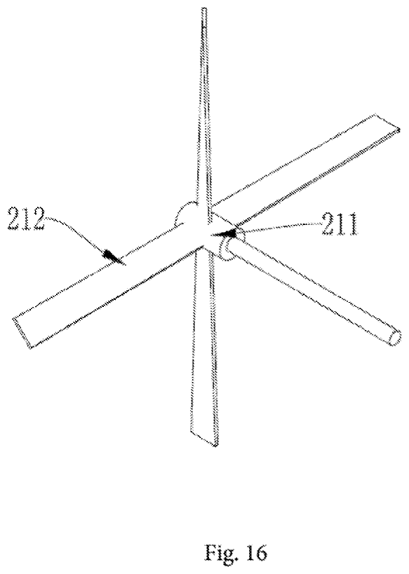

FIG. 16 is a perspective view of another embodiment of the stirring blade in the present invention.

The following call out list of elements can be a useful guide referencing the key element numbers of the drawings.
1 moving assembly
11 carriage
12 spindle mounting plate
13 drive reducer
14 drive gear
15 drive rack
16 Z direction drive reducer
17 screw assembly
18 Z direction mounting plate
19 rapid movement mechanism
191 linear guide slider assembly
2 stirring assembly
21 stirring blade
211 blade bar
212 blade body
22 mixing spindle
221 spindle drive motor
222 stirring spindle
223 spindle reducer
224 hollow rotary table
225 C-axis motor
23 return scraper
231 scraper blade
232 spindle reducer
233 hollow rotary table
234 C-axis motor
3 rack
4 coloring component also called pigment application assembly
41 cloth hopper
42 discharge roller
43 screen
44 storage barrel
441 interval section of a spray head row
442 color spray head
45 moving frame
46 walking drive
47 color storage barrel
5 pressing assembly
51 pressing roller
52 rotating base
53 cloth belt
54 rolling belt
55 conveyor belt for material

### DETAILED DESCRIPTION

### Glossary

X axis in a CNC machine is a first positional axis, usually in a left to right direction from the operator.
Y axis in a CNC machine is a second positional axis, usually in a front to back direction from the operator.
Z axis in a CNC machine is the third positional axis, usually in an up and down direction.
A axis in a CNC machine is the rotational axis around the X axis.
B axis in a CNC machine is the rotational axis around the Y axis.
C axis in a CNC machine is the rotational axis around the Z axis.

These are terms of art commonly used in CNC machining technology.

As shown in FIG. 1, an interlayer mixing device for artificial stone slab texture processing includes a pressing assembly 5, a coloring component 4, a stirring component 2, a moving assembly 1 and a control system. The plates are sequentially conveyed by conveyor belt to transport material to the working area of the pressing material assembly 5, the color application component 4, and the stirring assembly 2. The pressing material assembly 5, the coloring component 4, the moving assembly 1, and the stirring assembly 2 are connected to the control system.

The control system adjusts the pressing assembly 5 so that the pressing roller 51 applies a squeezing force to the stone material. The coloring component 4 applies color material to at least one surface of the layer to which the pressing force has been applied. Layer color material or according to the design path of the final product texture, applies at least one layer of color material at the corresponding position on the surface of the slab material.

The control system adjusts the moving assembly 1 and the stirring assembly 2 so that the moving assembly 1 drives the stirring assembly 2 above the slab after the squeezing force is applied, and according to the setting of the final product texture. As the stirring assembly 2 moves along its route, the stirring assembly 2 stirs at all programmed positions or partial corresponding positions on the surface of the slab, so that stirring occurs between the color material layer applied on top and the raw material mixture layer underneath.

The pressing assembly 5 and the stirring component 2 can be mounted together at the same station, or can be mounted separately as two independent stations connected by a belt. Driven by the belt, the stirring component 2 can be moved to the working area of the pressing assembly 5. The pressing assembly 5 applies a certain squeezing force to the slab or plate, and then, the color component 4 applies at least one layer of color to the surface of the slab or plate. According to cosmetic design, the color component 4 path of the final product texture, applies at least one layer of color material uniformly or unevenly on the corresponding position of the working surface. After application of the coloring material is completed, the moving assembly 1 drives the stirring assembly 2 to move along the extending path of the final product texture. At the same time, the stirring assembly 2 performs the stirring at the corresponding position according to the preprogrammed texture and design to facilitate stirring between the coloring material on an upper material layer and the raw material mixture on a lower material layer. The depth of the stirring may involve the thickness of the entire slab. The position of the agitated position after stirring and the position of the unstirred position will produce a color difference. Inside the mixture, after the texture processing and subsequent curing, pressing, thickness setting and other processes are completed, a transparent texture effect is left on the surface of the slab.

Before mixing, a certain squeezing force is applied to the slab material through the pressing assembly 5, so that the mixing occurs between the raw material mixture and the color material of the more compact plate material, and the material at the mixing position becomes loose again, and the material in the adjacent unstirred position is compacted due to the previous pressing, and there is a large barrier that allows the colorant to penetrate, so that the colorant is well maintained at the position where it is stirred, macroscopically making the final product textured. The boundary is clearer and more complete, and the consistency of the upper and lower textures and the texture permeability are good. The texture effects of the surface and the bottom layer are very clear, which truly achieves the natural crack effect.

For the specific implementation of the pressing assembly and the stirring component, there are the following two general embodiments.

### Example 1

As shown in FIG. 1 and FIG. 2, the pressing assembly 5 and the stirring assembly 2 are independently set at two stations, and the coloring component 4 also called the color application assembly enters the design area after squeezing force is applied. Before the working area of the stirring assembly 2 is defined, color material is applied to the surface of the slab.

The pressing assembly 5 and the stirring component 2 are set on two independent stations that are relatively spaced apart from each other. The slab can be handled so that it is movable such supported on a slab conveyor belt so that the slab passes the working area of the two components pass over the working area to complete their respective functions. Alternatively, the two components can be mounted at a single station or separately. The mounting locations reduce the time that the slab stays in one station, and reduces the waiting time for the next slab to start processing, thereby compacting the product process time and improving production efficiency. In addition, in a relatively independent station, one may operate variations of the process, although a flexible combination arrangement is required, where multiple pressing assemblies 5 and/or stirring components 2 can also be added in the middle according to process requirements, so as to achieve a richer texture effect.

In this embodiment, one of the corresponding setting methods of the color application component (that is, the first implementation of the application coloring component) is performed by a common dusting method, as shown in FIGS. 4 and 5. The conveying path of the conveyor belt, includes thereon a cloth hopper 41, a discharge roller 42 and a screen 43. The discharge roller 42 is provided at the outlet of the cloth hopper 41 to drive the color material to fall onto the surface of the slab material of the conveyor belt, so that the screen 43 is disposed below the discharge roller 42, and the control system drives the discharge roller 42 to rotate.

The application color material assembly 4 is fixed on the frame 3, and the slab is continuously driven by the conveyor belt. When the slab material moves to the application color material assembly 4, the control system drives the discharge roller 42 and the fabric to rotate. The color material in the hopper 41 is carried out by the discharge roller 42 to provide a natural fall to the surface of the slab material to apply the color material. The natural falling of powdered material provides a sprinkling effect.

The color application member 4 can apply at least one layer of color on the entire surface of the slab. The screen 43 provided below the discharge roller 42 filters the color material in the final step to ensure that there are no large lumps of color material sprayed onto the slab material to ensure the cloth effect.

Another corresponding arrangement method of applying coloring material components is shown in a second embodiment of applying coloring material components, which adopts a matrix dusting method, as shown in FIG. 6 and FIG. 7, which are arranged in the conveyance. On the conveying path of the belt, there is a color spray head 442 and a storage barrel 44. The inside of the storage barrel 44 is divided into spray head rows 441 arranged in relatively independent interval sections along the width direction of the conveyor belt, and the color spray head 442 is disposed at the bottom of the interval sections of the spray head rows 441, and the control system adjusts the opening and closing of the on-off control valve of the toner nozzle 442. The interval sections of the spray head rows 441 form an array of spray heads.

The dosing color component 4 is fixed on the frame 3, and the slab is continuously driven by the conveyor belt. When the slab moves to the color component 4 for color application, the control system drives the switch control valve of the color spray head 442 to open. The color material in the storage tank 44 naturally falls to the surface of the slab material through the color material spray head 442 to apply the color material.

The interval section 441 of the storage barrel 44 of the applied color material assembly 4 can be placed with different colors or different types of colorants. A plurality of colorant spray heads 442 are respectively arranged in the plurality of interval sections of the spray head rows 441 and are arranged along the lateral direction of the belt conveyor. This arrangement can ensure that the color material is covered in the width direction of the slab material, and each fixed nozzle is arranged below the storage barrel 44 to ensure that the material in the storage barrel 44 can be sprayed out.

As shown in FIGS. 1 and 2, in this embodiment, the pressing assembly 5 includes a cloth belt 53 for flattening and retaining the flour like powdered stone quartz. The powdered stone quartz has the consistency of flour dough. The pressing assembly 5 has a rolling belt 54 for dropping the stone powder and a conveyor belt 55 for feeding the rolling belt 54. The cloth belt 53 and rolling belt 54 can share a common drive motor so that they are commonly powered and controlled synchronously with the conveyor belt 55. The rolling belt 54 is provided under the cloth belt 53, and they can be overlapped with each other.

The conveyor belt 55 can be linearly reciprocated above the cloth platform, and during its movement, the rolling belt 54 can push and squeeze the powdered stone quartz onto the cloth platform. After enough material is stored on the cloth belt 53, the conveyor belt 55 moves the cloth belt 53 and the rolling belt 54 forward over the cloth platform. The cloth belt 53 is transported forward, and the rubbery material on it falls onto the rolling belt 54, and the roller belt 54 is transported forward, so that the rubbery material obtained on it falls into the mold on the cloth platform.

A height difference between the roller belt 54 and the cloth platform can be adjusted so that the roller belt 54 pushes and squeezes the powdered stone quartz during the distribution process, so that the powdered stone quartz continuously squeezes toward and against the side wall of the mold. The gap between the powdered stone quartz mass is eliminated and the mortar like material around the mold is extruded. The two previously separate processes of fabric and blank forming in the prior art are now completed in a single step together to improve work efficiency and avoid multiple blank transfer process iterations, thereby improving the quality of slab blank forming.

### Example 2

As shown in FIG. 3, in this embodiment, the coloring component 4 for color application and the stirring component 2 may be set at the same station. In this embodiment, the process of applying color material and stirring are completed at the same station, and the compaction assembly can also be set at the same station, or can be set relatively independently at another station, reducing the slab material in transfer steps between different processes, thus saving time. Although the slabs move along the assembly line conveyor belt, the

One of the corresponding setting methods of the application coloring material component of the present embodiment (that is, the third embodiment of the application coloring material component) is carried out by using the XYZ axis moving dusting method, which is provided on the moving component 1, and is moved by the moving assembly 1 together with the agitating assembly 2. The distributing coloring component 4 includes a coloring material spraying head and a coloring material bucket 47, and the coloring material spraying head communicates with the coloring material through a conveying pipe by which the barrel 47 is in communication.

Another corresponding setting method of the application coloring material component of this embodiment (i.e., the fourth implementation type of the application coloring material component) is also carried out by using the XYZ axis moving dusting method, as shown in FIGS. 8 and 9. The pressing material assembly 5, the application coloring material assembly 4 and the agitating assembly 2 are arranged on the frame 3, and the coloring component 4 comprises a coloring material spraying head, a coloring material pump and a color storage material barrel 47, and the coloring material spraying head is arranged. In the moving assembly 1, the color storage barrel 47 is independently provided on one side of the frame 3, and the color is provided on the conveying pipe between the color storage barrel 47 and the color spray head material pump.

The storage barrel 47 does not move with the moving sprinkler, which can reduce the weight of the moving frame 45 and its motion inertia, and improve the positioning accuracy when the mobile sprinkler starts and stops, or when it turns.

In this embodiment, the interlayer mixing device is provided on the frame 3, and the frame 3 is provided with a platform to receive the slab material. As shown in FIG. 3, the pressing assembly 5 is slidably arranged on the frame 3 along the conveying direction of the slab, and includes a pressing roller 51 and a rotating base 52. The length direction is perpendicular to the conveying direction of the slab material, and both ends thereof are rotatably disposed on the rotating base 52. The rotating base 52 is disposed on the frame 3 through the wheel body, so that the pressing assembly 5 can move along the frame 3. When the slab material is transported in a sliding direction, the nip roller 51 squeezes and rolls from the end surface of the slab material.

The pressure roller 51 is arranged above the conveyor belt parallel to the conveyor belt. During the process of the conveyor belt entering the working area of the stirring assembly 2 with the conveyor belt, the pressing force is applied by the pressure roller under the pressure roller 51. The height of the press roller in the vertical direction can be adjusted to meet the processing of different thicknesses of slabs.

Furthermore, as shown in FIG. 3, the moving component 1 is an XYZ three-axis driving device, which can drive the stirring component 2 to make a straight line in the three directions of the X axis, the Y axis, and the Z axis relative to the frame 3 in reciprocating motion. The XYZ three-axis drive device is electrically connected to the control system. The stirring assembly 2 includes a stirring blade 21 and a driving device 22. The driving device 22 can drive the stirring blade 21 to rotate in a vertical plane.

In this embodiment, the moving assembly 1 is a driving device with degrees of freedom in the three directions of the X axis, the Y axis, and the Z axis. Any conventional structure that can carry the stirring assembly 2 in a linear reciprocating motion in the above three directions should suffice. Within the scope of protection of the present invention, such conventional structures include various forms of structures composed of one or more combinations of conventional equipment such as motors, cylinders, gear racks, slide rail sliders, cams, sprockets, screw rods, etc. A specific embodiment of the moving assembly 1 is, as shown in FIG. 10, including a carriage 11, an X-direction drive member, a Y-direction drive member, a Z-direction drive member and a spindle mounting plate 12. An X-direction drive member, a Y-direction drive and a Z-direction drive are electrically connected to the control system. The X-direction drive drives the carriage 11 to reciprocate linearly in the X direction relative to the frame 3, and the stirring assembly 2 is set through the spindle mounting plate 12. In the traveling frame 11, the Y-direction driving member drives the spindle mounting plate 12 to reciprocate linearly in the Y direction relative to the frame 3. The stirring assembly 2 is provided on the spindle mounting plate 12 through the Z-direction driving element up and driven by the Z-direction drive to make a linear reciprocating movement in the Z-axis direction.

Further, the X-direction drive member and the Y-direction drive member are both structures including a drive reducer 13, a drive gear 14 and a drive rack 15. The drive rack 15 in the X-direction drive member is provided on the frame 3 and extended along the X-axis direction. The drive reducer 13 and the drive gear 14 are mounted on the carriage 11. The drive reducer 13 drives the drive gear 14 to rotate and reciprocates along the drive rack 15 in a straight line. The driving rack 15 is provided on the traveling frame 11 and extends along the Y-axis direction, and the driving reducer 13 and the driving gear 14 are mounted on the spindle mounting plate 12. The driving reducer 13 drives the driving gear 14 to rotate and along the driving rack 15 to make a linear reciprocating motion.

The Z-direction drive is a Z-direction drive reducer 16, a screw assembly 17 and a Z-direction mounting plate 18. The stirring assembly 2 is provided on the Z-direction mounting plate 18. The Z-direction mounting plate 18 is fixedly connected to the nut of the screw assembly. The screw of the rod assembly 17 is rotatably provided on the spindle mounting plate 12, and extends along the direction of the Z axis, and rotates under the drive of the Z-direction drive reducer 16. The screw assembly 17 is used to achieve moving position fine adjustment and precise positioning. Further, a fast moving mechanism 19 is provided above the spindle mounting plate 12, and the fast moving mechanism 19 can drive the stirring assembly 2 to move up and down in the vertical direction quickly, that is, when the stirring spindle 222 is not in operation, the stirring assembly 2 is carried for quickly rising and resetting. When working, the stirring assembly 2 can be quickly lowered to a position close to the processing surface, and then the spindle mounting plate 12 can be lowered through the Z-direction driving member, so that the stirring blade 21 falls accurately to the processing position, and the processing efficiency and precision are improved. The fast-moving mechanism 19 here may be one or more of mechanical structures such as cylinders, cylinders, gears, cams, sprockets and so on.

Preferably, the driving gear 14 and the driving rack 15 here are helical gear racks, and the tooth overlap of the helical gear rack is large, which reduces the force of each tooth, making the driving gear 14 and the driving rack 15 more durable and transmission more stable with low noise. In order to further improve the stability of the movement in all directions, between the walking frame 11 and the frame 3, before the walking frame 11 and the spindle mounting plate 12, the linear guide slider assembly 191 is provided at the position where the two are in contact with each other. The linear guide rail has low frictional resistance to movement, wear and tear for a long time, and good accuracy.

The agitating component 2 applies at least one layer of color material on the surface, or works on the plate material applying at least one layer of color material at a corresponding position on the surface of the plate material according to the design path of the final product texture. The slab is placed horizontally, and the driving device 22 drives the stirring blade 21 to rotate in a vertical plane. When passing through the slab, the raw material mixture of the color material and the slab are stirred with a tangential force. The depth of the stirring may involve the entire slab thickness. There is a color difference between the agitated position and the non-agitated position after agitation, which after agitation causes the color material to penetrate into the raw material mixture of the slab. After the texture processing and subsequent curing, pressing, and thickness setting are completed, the plate surface of the material leaves a transparent texture effect.

The material mixture of the color material and the slab material is stirred with a tangential force. Compared with the stirring of the color material and the material mixture by the rotation force perpendicular to the plate material, this technical solution can obtain a finer stirring path. The stirring path obtained by tangential force stirring is the thickness of the tool itself, and if the rotation force obtained by using the rotation force perpendicular to the slab is twice the width of the tool, no matter how the width of the tool is adjusted. There is a process of obtaining a fine texture. Above, the solution of the present invention has outstanding advantages, and from the perspective of actual use, it is impossible for the stirring blade 21 to be made too thin in order to obtain a fine texture. Here, too thin means that the strength of the blade itself is reduced, and stirring has a certain adhesion. When the raw material mixture is mixed, problems such as breakage are extremely easy to occur.

As shown in FIGS. 11, 12 and 13, the drive device 22 includes a spindle drive motor 221, a stirring spindle 222, a spindle reducer 223, a hollow rotary table 224 and a C-axis motor 225. The spindle drive motor 221 drives the stirring spindle 222 rotation. The stirring spindle 222 passes through the hollow rotary table 224 and drives the output shaft of the spindle reducer 223 to rotate. The output shaft of the spindle reducer 223 is arranged horizontally and horizontally, and it drives the stirring blade 21 to rotate in a vertical plane. The C-axis motor 225 is disposed on one side of the stirring spindle 222, and its output shaft can drive the spindle reducer 223 to rotate relative to the stirring spindle 222. From a top view, this would allow drawing of curves and arcs because the Z axis is the vertical axis for determining a height, and thus the C axis is the rotational axis about the Z axis.

The stirring blade 21 follows the spindle reducer 223 and rotates relative to the stirring spindle 222. The stirring blade 21 is driven by a spindle drive motor 221, a stirring spindle 222 and a spindle reducer 223. The stirring blade 21 could be mounted on a chuck for easy replacement. The output shaft of the spindle reducer 223 is arranged horizontally and horizontally, driving the stirring blade 21 to rotate horizontally, and the horizontal rotating stirring blade 21 to the plate. During the texture mixing process, the horizontal rotating stirring blade 21 can lift the agitated material upward, and then lift it back to the position of the mixing texture. At the same time, it also acts as a filler to ensure that the agitated texture position will not cause the density of the board to be reduced or small hole defects due to lack of material. The moving trajectory of the stirring blade 21 is determined according to the set texture path. When moving to the corner of the path, the C-axis motor 225 drives the hollow rotary table 224 to rotate through an angle. The angle of rotation is determined by the turning angle of the preset path. The rotation of the rotary table 224 drives the stirring blade 21 to follow rotation, ensuring that the cutting direction of the stirring blade 21 can preferably be always kept in the tangent direction with the moving track when turning, so that the path angle of the path cut by the stirring transition is smooth, if such a smooth design is desired.

As shown in FIGS. 14 and 15, the stirring blade 21 includes a blade bar 211 and a blade body 212. The blade bar 211 and a plurality of blade bodies 212 are combined into a fully detachable petal structure. The blade bar 211 is located at the center of the petal structure, and the other end extends outward in a direction perpendicular to the end surface of the blade body 212. The end of the blade body 212 extends from the center of the petal structure and extends outwardly. By replacing the blade body 212 and blade bar 211 of different specifications, a blade with a petal structure of various diameters can be assembled to meet the stirring needs of various texture effects. The blade body 212 is planar and all the end surfaces of the blade body 212 are in the same plane. The middle portion of the blade body 212 is detachably attached to one end of the cutter bar 211 by connectors such as bolts. The free end of the cutter body 212 is bent toward the side away from the cutter bar 211 to form a bent portion 2110.

The blade body 212 is flat and in the shape of a plane. The end surfaces of all the blade bodies 212 are in the same plane. A fine texture range can be cut when stirring and cutting the slab. In addition, the blade body 212 can also be made into an end bend (that is the free end of the blade body 212 is provided with a bent portion 2110), so that a larger texture range can be stirred.

As shown in FIG. 16, the blade body 212 is in a flat shape, all the end surfaces of the blade body 212 are parallel to the extending direction of the blade bar 211, and one end of the blade body 212 is detachably inserted into the blade at the outer side wall of the rod blade bar 211. The blade body 212 is a rectangular slab or a wedge-shaped slab or a slab whose outer contour is composed of a spiral curve.

As shown in FIG. 11, a scraper blade 231 is provided on the rear side of the stirring blade 21, and the back scraper 23 is provided at the front end of the spindle reducer 223, and its plate surface is perpendicular to the stirring plane of rotation of the blade 21. During the lifting and falling process of the stirring blade 21, some materials will be scattered outside the setting range of the texture stripes. By setting the material return scraper 23 on the rear side of the stirring blade 21, the material will be scattered. In the setting range of the outer material backfilling into the texture stripes, the height between the material return scraper 23 and the end surface of the material can be an adjustable structure. By adjusting the height of the material return scraper 23, the amount of material backfilling is controlled to improve efficiency.

The return scraper 23 is an angular structure composed of a scraper blade 231 and a fixed plate 232. The fixed plate 232 is disposed on the spindle speed reducer 223 so that the scraper blade 231 is located on the stirring blade 21 rear side. The structure is simple, easy to install and use.

The height position of the return scraper 23 on the spindle speed reducer 223 is adjustable. The method for adjusting the height in this embodiment may be to provide a plurality of buckling positions in the height direction, and the return scraper 23 may be fixed to different buckling positions to achieve height adjustment, or may be through a rack and pinion. The adjustment methods involved in automatic accessories such as motors or cylinders, such as slider rails, that is, height adjustment structures commonly used by those skilled in the art should fall within the protection scope of the present invention.

Assembly of the machine begins with mounting the moving assembly 1 is movably mounted over the frame 3, and supporting a stirring assembly 2 that is mounted to the moving assembly 1. The moving assembly also has a carriage 11, a spindle mounting plate 12, a drive reducer 13, a drive gear 14, a drive rack 15, a Z-direction drive reducer 16, a screw assembly 17, a Z-direction mounting plate 18, a rapid movement mechanism 19, and a linear guide slider assembly 191. Then, the mixing assembly 2, is mounted to the moving assembly 1. The mixing assembly 2 has a stirring blade 21, blade bar 211, blade body 212, mixing spindle 22, spindle drive 23, scraper blade 231, spindle reducer 232, hollow rotary table 233, C-axis motor 234, and return scraper 24. Then, the coloring component 4 is mounted over the frame 3 and configured so that it distributes color. The coloring component 4 has a cloth hopper 41, a discharge roller 42, a screen 43, a storage barrel 44, interval spaced sections of spray head rows 441, color spray heads 442, a moving frame 45, a walking drive 46, and a color storage barrel 47. Then, the pressing assembly 5 is mounted over the frame 3. The pressing assembly translates across the frame 3 and has a pressing roller 51, a rotating base 52, a cloth belt 53, a rolling belt 54, and a conveyor belt 55. The walking drive 46 can be a step motor.

The technical principles of the present invention have been described above in conjunction with specific embodiments. These descriptions are only for explaining the principle of the present invention, and should not be interpreted in any way as limiting the protection scope of the present invention. Based on the explanation here, those skilled in the art can associate other specific embodiments of the present invention without creative efforts, and these methods will fall within the protection scope of the present invention.

1. An interlayer mixing device for texture processing of artificial stone slabs comprising:
a. a frame formed as a rack;
b. a pressing assembly mounted on the rack;
c. a color application component mounted on the rack;
d. a stirring component mounted on the rack;
e. a moving component mounted on the rack; and
f. a control system, wherein plate materials are transported to pressing materials in sequence by a conveyor belt to working areas of the color application component and the stirring component; wherein the pressing assembly, the application component, the moving component and the stirring component are respectively connected to the control system; wherein the control system adjusts the pressing assembly so that the pressing assembly applies squeezing force to a slab; wherein the color application component distributes at least one layer of coloring material to a slab to which pressing force has been applied or follows a path of a texture design on the slab; wherein at least one color layer is applied on the slab; wherein the control system adjusts the moving component and the stirring component so that the moving component drives the stirring component above the slab material after the pressing force is applied, wherein the control system sets a route of the final product texture while at the same time controlling the stirring component to stir at all corresponding positions or partial corresponding positions on the surface of the slab, and wherein stirring occurs at an interface between the color layer and raw material mixture between the plates.

2. The interlayer mixing device of claim 1, wherein the pressing assembly and the stirring component are independently arranged in two stations, and wherein the color application component is subjected to a squeezing force, wherein before the slab material enters the working area of the stirring assembly the color application component applies colorant to the surface of the slab material.

3. The interlayer mixing device of claim 2, wherein the color application component has a cloth material and is disposed on the conveying path of the conveyor belt, and includes a cloth hopper, a discharge roller and a screen providing a discharge; wherein the roller is provided at the outlet of the cloth hopper for driving the color material to fall to the surface of the slab of the conveyor belt, the screen is provided below the discharge roller, and the control system drives the outlet the feed roller rotates.

4. The interlayer mixing device of claim 2, wherein the color application component is disposed on the conveying path of the conveyor belt, and includes a color material spray head and a storage barrel; wherein the interior is divided into a plurality of relatively independent interval sections along the width direction of the conveyor belt, the toner nozzle is disposed at the bottom of the interval section, and the control system adjusts the opening and closing of the on-off control valve of the toner nozzle.

5. The interlayer mixing device of claim 2, wherein the pressing assembly includes a cloth belt, a rolling belt and a walking device for flatly storing the material, the cloth belt and the rolling device, wherein the belt is arranged on the same walking device, and the rolling belt is arranged under the cloth belt; the walking device can be linearly reciprocated above the cloth platform during its movement, wherein the rolling belt pushes and squeezes material on the cloth platform.

6. The interlayer mixing device of claim 1, wherein the color application component and the stirring component are arranged at the same station.

7. The interlayer mixing device of claim 6, wherein the applying coloring material component is provided on the moving component, and is moved by the moving component together with the stirring component; the applying color, wherein the material assembly includes a color material spray head and a color storage material barrel, and the color material spray head communicates with the color storage material barrel through a conveying pipe.

8. The interlayer mixing device of claim 6, wherein the pressing assembly, the color application component and the stirring component are provided on the rack, and the color application component includes a coloring material spraying head and a coloring material pump and a color storage barrel, wherein the color spray head is disposed on the moving assembly, the color storage barrel is independently disposed on one side of the frame, and the color storage barrel is between the color storage barrel and the color spray head, wherein the coloring material pump is arranged on the conveying pipe.

9. The interlayer mixing device of claim 6, wherein a frame is provided with a platform for receiving the plate material; wherein the pressing assembly, the color application component, the stirring component and the moving component are glidingly arranged on the frame in the conveying direction of the slab material; further including a pressing roller and a rotating base; wherein a lengthwise direction of the pressing roller is perpendicular to the conveying direction of the slab material, and both ends thereof are rotatably arranged, wherein in the rotating base, the rotating base is disposed on the frame through a wheel body, so that when the pressing assembly slides along the conveying direction of the slab, the pressing roller squeezes from the end surface of the slab roll over. I don't know

10. The interlayer mixing device according to claim 1, wherein the moving component is an XYZ three-axis drive device, which drives the stirring component relative to the frame in the three X-axis, Y-axis and Z-axis directions, wherein the XYZ three-axis drive device is electrically connected to the control system; wherein the stirring assembly includes a stirring blade and a driving device, wherein the driving device can drive the stirring blade to rotate in a vertical plane, wherein the driving device includes a spindle drive motor, a stirring spindle, a spindle reducer, a hollow rotary table, and a C-axis motor, wherein the spindle drive motor drives the stirring spindle to rotate, and the stirring spindle passes through the hollow rotary table and drive the output shaft of the spindle reducer to rotate, wherein the output shaft of the spindle reducer is arranged horizontally and horizontally, and drives the stirring blade to rotate in a vertical plane; wherein the C-axis motor is provided with the stirring spindle on one side, and wherein an output shaft drives the spindle reducer to rotate relative to the stirring spindle, wherein the stirring blade rotates with the spindle reducer relative to the stirring spindle.
